(19) United States
(12) Patent Application Publication
(10) Pub. No.: US 2016/0249178 A1
(43) Pub. Date: Aug. 25, 2016

(54) METHODS AND SYSTEMS USED IN TRACKING MOBILITY IN A DWELLING

(71) Applicants: Daniel Austin, Portland, OR (US); Jeffrey Kaye, Portland, OR (US); Tamara Hayes, Beaverton, OR (US); Robin M. Cross, Corvallis, OR (US)

(72) Inventors: Daniel Austin, Portland, OR (US); Jeffrey Kaye, Portland, OR (US); Tamara Hayes, Beaverton, OR (US); Robin M. Cross, Corvallis, OR (US)

(21) Appl. No.: 15/048,739

(22) Filed: Feb. 19, 2016

Related U.S. Application Data
(60) Provisional application No. 62/118,074, filed on Feb. 19, 2015.

(51) Int. Cl. H04W 4/02; H04W 4/04; H04L 29/08

(52) U.S. Cl. CPC H04W 4/028; H04L 67/12; H04W 4/043

(57) ABSTRACT

Computer implemented methods of identifying in-dwelling mobility patterns of a subject are disclosed. The methods involve collecting information from a plurality of sensors in the dwelling of the subject. Contextual variables associated with the dwelling, the subject, and/or the surroundings of the dwelling are determined. A mobility pattern within the dwelling based upon the data and the contextual variables is calculated using a regression model.

### ACKNOWLEDGEMENT OF GOVERNMENT SUPPORT

This invention was made with the support of the United States government under the terms of grant numbers R01 AG024059, P30 AG024978, and P30 AG008017 awarded by the National Institutes of Health. The United States government has certain rights to this invention.

### FIELD

Generally, the field is the monitoring of movement of a subject. More specifically, the field is the monitoring of the movement of a subject within a dwelling.

### BACKGROUND

Many factors influence human mobility, spanning the continuum from regular and predictable commitments (e.g., commuting for work or taking a child to school) to unforeseen circumstances (e.g., travelling to help a sick relative or pausing to fix a flat tire) while also encapsulating individuals' preferences, wants, needs, and contextual effects (e.g., weather conditions or current health status). Despite the seemingly diverse array of reasons for which individuals move around (Brockman D et al, Nature 439, 462-465 (2006); Simini F et al, Nature 484, 96-100 (2012); Song C et al, Science 327, 1018-1021 (2010); Onnela J P et al, Proc Natl Acad Sci USA 104, 7332-7336 (2007); Hui P and Crowcroft J, Philos Transact A Math Phys Eng Sci 366, 2005-2016 (2008); and Rybski D et al, Proc Natl Acad Sci USA 106, 12640-12645 (2009); all of which are incorporated by reference herein), a large body of work has found significant regularity and predictability in human mobility patterns, primarily in the form of scaling properties and power laws (Candia J et al, J Phys A: Math Theor 41, 224015 (2008); Gonzlaez M C et al, Nature 453, 779-782 (2008); Song C et al, Nature Phys 6, 818-823 (2010); Bargrow J P and Lin Y R, PLoS One 7, e37676 (2012); and Qin SM PLos One 7, e51353 (2012); all of which are incorporated by reference herein) using location data collected predominantly from cell phones (Eagle N and Pentland A, Behav Ecol Scoiobiol 63, 1057-1066 (2009); Eagle N et al, Proc Natl Acad Sci USA 106, 15274-15279 (2009); and Palla G et al, Nature 466, 664-667 (2007); all of which are incorporated by reference herein). These findings have importance to a diverse array of applications such as optimization of transportation systems (Varaiya P, Philos Transact A Math Phys Eng Sci 366, 1921-1930 (2008) and Wilson R, Philos transact A Math Phys Eng Sci 366, 2017-2032 (2008); both of which are incorporated by reference herein) and controlling the spread of infectious disease (Eubank S et al, Nature 429, 180-184 (2004); Gushulak B D and MacPherson D W, Clin Infect Dis 31, 776-780 (2000); and Hufnagel L et al, Proc Natl Acad Sci USA 101, 15124-15129 (2004); all of which are incorporated by reference herein). To date, these studies have focused on human mobility outside of the personal home space. In part, this reflects the commonly used proxies for human mobility, such as cell phone records, which lack the spatial and temporal resolution to resolve movements on the scale present in home space. However, much of the population spends a significant proportion of their time at home—especially as they age (Kaye J A et al, J Gerontol B Pshychol Sci Soc Sci 66 Suppl1: i180-190 (2011); incorporated by reference herein)—suggesting that mobility in the home is an important facet of human behavior. Clearly, systems that better monitor mobility of subjects within a dwelling are necessary.

### SUMMARY

Computer implemented methods of identifying in-dwelling mobility patterns of a subject are disclosed. The methods involve collecting information from a plurality of sensors in the dwelling of the subject. Contextual variables associated with the dwelling, the subject, and/or the surroundings of the dwelling are determined. A mobility pattern within the dwelling based upon the data and the contextual variables is calculated using a regression model.

### BRIEF DESCRIPTION OF THE SEVERAL VIEWS OF THE DRAWINGS

FIG. 1A: Time series plots of in-home mobility for 5 different participants (color coded) for daily-mobility over 31 days starting Nov. 1, 2011.

FIG. 1B: Time series plots of in-home mobility for 5 different participants (color coded) for daily-mobility over 2-minute increments for four hours of Nov. 2, 2011. Mobility, in units of room-transitions, at the day level is impulsive occasionally changing by a factor of 2 or more. Mobility at the 2-minute level is also impulsive and demonstrates that day-level mobility is comprised of periods of little-to-no mobility interspersed with bursts of movement.

FIG. 1C: Day-level data for 5 representative homes is shown (circles) with best fit power laws (dashed lines), indicating good fit for individual homes but not across homes. Note that as the cumulative distribution function was plotted for the power laws, the slopes in the plot are −α+1 for each participant's value of α.

FIG. 1D: Data at the two-minute level was not consistent with a power law distribution but is still heavy-tailed.

FIG. 2A: The predictability of in-home mobility, defined as the proportion of correct estimates, is shown as a function of allowable error. For example, 95.8% of mobility estimates are within 1 of observed values, and over 99% of mobility estimates are within 3 of observed values.

FIG. 2B: The difference between estimated and observed probabilities are shown (black line) as a function of mobility. The y=0 line (gray dashed line) represents perfect predictability. The regression model over estimates 0's by 1%, underestimates 1's by 1.2%, and is off by less than 0.2% for the rest of the mobility values. Confidence intervals on the predictability have been omitted as they are too small to distinguish from the figure traces.

FIGS. 3A-3D collectively show probability density (color represents density; discrete probabilities were linearly interpolated for graphical clarity) of mobility (y-axes) as a function of four different contextual variables (x-axes) that vary across different time scales, holding all other variables at constant values. The mean function, μ (black trace) with 95% confidence intervals (CI; dashed black trace), has been overlaid on the density to show central tendency in each panel.

FIG. 3A shows that mobility declines with increasing age, where expected mobility decreases by a factor of 0.83 as age increases from 71 to 97 years.

FIG. 3B shows that mobility increases with increasing walking speed among the peer reference group (expected mobility increases by a factor of 1.9 as peer referenced walking speed increases from 20 cm/s to 260 cm/s).

FIG. 3C shows that mobility increases with maximum daily outdoor temperature (expected mobility increases by a factor of 1.12 as maximum temperature increases from 5° C. to 37° C.).

FIG. 3D shows that mobility increases with increased socioeconomic status (expected mobility doubles as socioeconomic status increases from a score of 8 to 65).

FIGS. 4A-4D collectively show that the estimated probability of no movement with 95% confidence intervals (Cl) as a function of 4 different contextual variables (x-axes), holding all other variables at constant values (including gender=female, same as the values in FIG. 3).

FIG. 4A shows that the probability of no movement increases by a factor of 1.7 as age increases from 71 to 97 years.

FIG. 4B shows that the probability of not moving decreases with increasing walking speed of the peer reference group (probability decreases by a factor of 0.1 as peer referenced walking speed increases from 20 cm/s to 260 cm/s).

FIG. 4C shows that the probability of not moving decreases with increasing maximum daily outdoor temperature (probability decreases by a factor of 0.71 as maximum outdoor temperature increases from 5° C. to 37° C.).

FIG. 4D shows that the probability of not moving decreases with increasing socioeconomic status (probability decreases by a factor of 0.17 as socioeconomic status increases from 8 to 65). Socioeconomic status has been plotted with a different y axis range than the other three variables as it has a larger range.

FIG. 5A is a time series plot of in home mobility for daily mobility over 31 days starting Nov. 1, 2011.

FIG. 5B is a time series plot of in home mobility for 2-minute increments for four hours of Nov. 2, 2011.

FIG. 5C depicts day-level data for 5 homes shown (circles) with best fit power laws (dashed lines), indicating good fit for individual homes but not across homes. Note that as the cumulative distribution function for the power laws has been plotted, the slopes in the plot are −α+1 for each participant's value of α.

FIG. 5D depicts that Data at the two-minute level was not consistent with a power law distribution but is still heavy-tailed. Participant 6's data was not consistent with a power law at the day level (black) with no power law trace in (C). Dates shown were chosen to show one month worth of data for all homes.

FIG. 6A is a time series plot of in-home mobility showing daily-mobility over 31 days starting Jul. 7, 2009.

FIG. 6B is a time series plot of in home mobility for 2-minute increments for four hours of for four hours of Jul. 7, 2009.

FIG. 6C is a plot depicting day-level data for 4 homes is shown (circles) with best fit power laws (dashed lines), indicating good fit for individual homes but not across homes. Note that as the cumulative distribution function has been plotted for the power laws, the slopes in the plot are −α+1 for each participant's value of α.

FIG. 6D is a plot depicting data at the two-minute level was not consistent with a power law distribution but is still heavy-tailed. Dates shown were chosen to show one month worth of data for all homes.

FIG. 7A is a time series plot of in-home mobility showing daily-mobility over 31 days starting Aug. 1, 2009.

FIG. 7B is a time series plot of in home mobility for 2-minute increments for four hours of for four hours of Aug. 1, 2009.

FIG. 7C is a plot depicting day-level data for 4 homes is shown (circles) with best fit power laws (dashed lines), indicating good fit for individual homes but not across homes. Note that as the cumulative distribution function has been plotted for the power laws, the slopes in the plot are −α+1 for each participant's value of α.

FIG. 7D is a plot depicting data at the two-minute level was not consistent with a power law distribution but is still heavy-tailed. Dates shown were chosen to show one month worth of data for all homes.

### DETAILED DESCRIPTION

Recent advances in ubiquitous computing and in-home monitoring have provided opportunities to monitor individuals in their personal home space both passively and unobtrusively via motion sensors and other devices (Cook D J, J Univers Comp Sci 12, 15-29 (2006); Hagler S et al, IEEE Trans Biomed Eng 57, 813-820 (2010); Hayes T et al, Pervasive Comp 6, 36-43 (2007); and Skubic M et al, Technol Health Care 17, 183-201 (2009); all of which are incorporated by reference herein) providing the opportunity to study continuous behavioral characteristics in the home setting for the first time. Current methods of in-home monitoring are somewhat different than out-of-home monitoring in that they lack a common measurement system for all individuals, such as common cell phone towers used to measure mobility out-of-home. This is due in part to heterogeneity of the home space (size, furniture placement, etc.) and in-home sensor networks (number of sensors deployed, sensor placement in the home, etc.), making the spatial aspect of mobility less comparable across individuals. In particular, the opportunity space an individual has in which to move temporally (e.g., size, number of sensors, average recorded mobility) can be accounted for, but it is difficult to make meaningful cross-sectional comparisons when individuals' spatial locations do not map across people (e.g., not everyone has a computer room or second bedroom). Disclosed herein is a measure of the temporal regularity and predictability of mobility, mᵢ, where mobility is defined as the number of times an individual moves between different rooms in their home—a count variable quantifying an individual's number of movements in a specified time interval i.

The disclosure herein focuses on two main questions, both of which address aspects of predictability and regularity in human mobility not previously examined. First, whether scaling laws in human mobility similar to those demonstrated outside the home also hold inside the home. Second, whether including context in a model of human mobility uncovered regularity not accounted for by modeling mobility with a single, time independent power law mobility distribution. It is disclosed that while a power law is not a plausible representation for the observed in-home mobility data, by explicitly including context in a model of human mobility a high level of predictability and structural regularity can be obtained. These results suggest that in-home mobility is also highly stereotyped, albeit in a different way, which may have applications to predicting individual human health and functional status (Evans D A et al, Alzheimers Dement 7, 110-123 (2011); Kaye J et al, Gait Posture 35, 197-202 (2012); both of which are incorporated by reference herein) by detecting adverse events or trends and in conducting more meaningful clinical trials (Carlsson C M, J Alzheimers Dis 15, 327-338 (2008) and Kaye J, Alzheimers Dement 4, S60-66 (2008); both of which are incorporated by reference herein).

As described herein, a subject can be any complex animal large enough to have its movement detected by one or more sensors. A subject therefore includes a human subject including a human subject of any age or with any ailment or plurality of ailments, including a human subject that is a participant in a clinical trial. A subject can also include an animal subject such as a captive animal subject (such as a research animal subject, a companion animal subject, a livestock animal subject, or a zoo animal subject) or a wild animal subject, particularly an endangered wild animal subject.

As described herein, a sensor can be any device that detects the motion of a subject through a dwelling. Examples of such sensors include but need not be limited to, passive IR motion activity sensors, magnetic contact sensors, load cells (indicating presence on or off a surface such as a bed or toilet) door contact switches, phone sensors, indicators that show that a subject has logged onto or off a computer, a medication tracker, a weight scale, or any other device that can detect the presence of a subject in a space, the absence or a subject from a space, or the movement of a subject through a space. Such sensors include all devices currently in existence and those yet to be invented.

A dwelling can be any enclosed or enveloped space where a subject sleeps habitually, or at least the majority of the time spent sleeping. For a human subject, a dwelling can include a “single family” house, an apartment in a multi-dwelling structure, or any other structure for habitation. For a non-human subject, a dwelling can be a den, nest, colony, cave, or other similar structure. As described herein, an ‘in-home’ system refers to a system used in a dwelling.

A contextual variable can be any characteristic of the subject, the dwelling, or the environment surrounding the dwelling (such as the weather, the time of year, natural or artificial structures and features, etc.) that can have an effect on the movement of the subject within the dwelling. Nonlimiting examples of contextual variables are described in Table 2 and elsewhere in the disclosure.

### Analyses

Power Law Analysis: The data used in the power law analysis were the mobility, mᵢ, of all 19 subjects at both i=2 minutes and i=24 hours (calculated from midnight to midnight). mᵢ, the number of times an individual moves between different rooms in their home, is calculated from the motion sensor data stream as the number of times that sensors firing adjacently in time are different. The motion sensor data stream is constructed as the time ordered sensor stream of all the sensors that fired in the interval, i, plus the last sensor firing from the prior interval. From this stream the number of adjacent sensors (in the forward-in-time direction only) that are different can be counted. For example, if the motion sensor stream for interval i was: Living Room→Living Room→Bathroom→Kitchen, then mᵢ would be set at a value of 2 (for the Living Room→Bathroom and BathroomΔKitchen).

To determine whether similar power law behavior (as a data generating process) is consistent for in-home mobility as has been shown to hold for out-of-home mobility, the guidelines and Matlab code described in Clauset, et al 2009 infra were used to estimate the parameters of and assess the goodness of fit for truncated power laws of the form p(m)˜m^{-α} for mₘᵢₙ≦m with a slight refinement for the case of p(m)˜m^{-α} for mₘᵢₙ≦m≦mₘₐₓ. The analysis proceeds as follows. First, it is assumed that a power law holds (as the null hypothesis) and then estimate the parameters, mₘᵢₙ, mₘₐₓ, and α. This is done with a sequential estimation procedure as follows:
1) Estimate mₘᵢₙ, α, and the goodness of fit with Kolmogorov-Smirnov (KS) test statistic as described in Clauset A et al, SIAM Review 51, 661-703 (2009); incorporated by reference herein.
2) If the p-value from the KS test is greater than or equal to 0.1, stop. mₘₐₓ is estimated as the largest data point in the set of mobility values.
3) If the p-value from the KS test is less than 0.1, remove all instances of the largest mobility value from the data set and start over at step 1.

This procedure either produces a plausible power law (assessed by the goodness of fit from the KS test, p≧0.1) that fits the largest range of the mobility data or terminates with no power law found that is plausible with the data (since the mobility data is integer valued, this procedure will terminate in a finite number of steps). This procedure does not validate that a power law is the correct data generating mechanism, only that it is a plausible data generating process for the observed data (specifically, the goodness of fit against alternative data generating processes was not tested). Further, removing data points (step 3) is valid because this is not an attempt to model the data outside of the plausible power law range—doing so admits a simple brute force approach to estimate mₘₐₓ. This procedure was applied for i=2 minutes and 24 hours.

For i=24 hours, mᵢ was first normalized by the home-specific median over the entire data set for the home and the number of active sensors in the home. This normalization was intended to mitigate the effect on mobility of different home floor plans, sensor placement, number of sensors, and personal levels of mobility. This individual-specific normalization constant was intended to be closely related to radius of gyration used to characterize the size of an individual's trajectory from cell phone data (out-of-home mobility) and is a function of the time t for which the user is observed. The radius of gyration was a crucial parameter that normalized individual mobility patterns in such a way that out-of-home mobility was shown to have a single distribution independent of each individual phone user after the normalization.

Since spatial characteristics were not specifically accounted for in the data, the average size of the trajectory in space could not be characterized. However, the average size (count) of the trajectory in time (i.e, the average amount of mobility observed as a function of time) could be. Median day level mobility was selected as this normalization constant for several reasons. First, the median is a more robust measure of central tendency than the mean. Second, for distributions that are non-negative and non-symmetric, the sample median is not leveraged by large observations as is the sample mean. Third, the median is a value taken by the observed process (it is an integer whereas the mean, for example, may not be). Finally, the daily mobility was divided by the number of active sensors in each home on each day to account for the “opportunity space” in which transitions are observed (e.g., number of different rooms) and to adjust for technical issues with sensors (e.g., a broken sensor that does not capture mobility) both of which may impact longitudinal and cross sectional comparisons if not accounted for. It is further believed that the median helps normalize the effect of an individual's mobility for cross-sectional comparison of scaling exponents because it tends to contain some of the same distance information that is unmeasured but implicitly present in the count mobility time series under analysis.

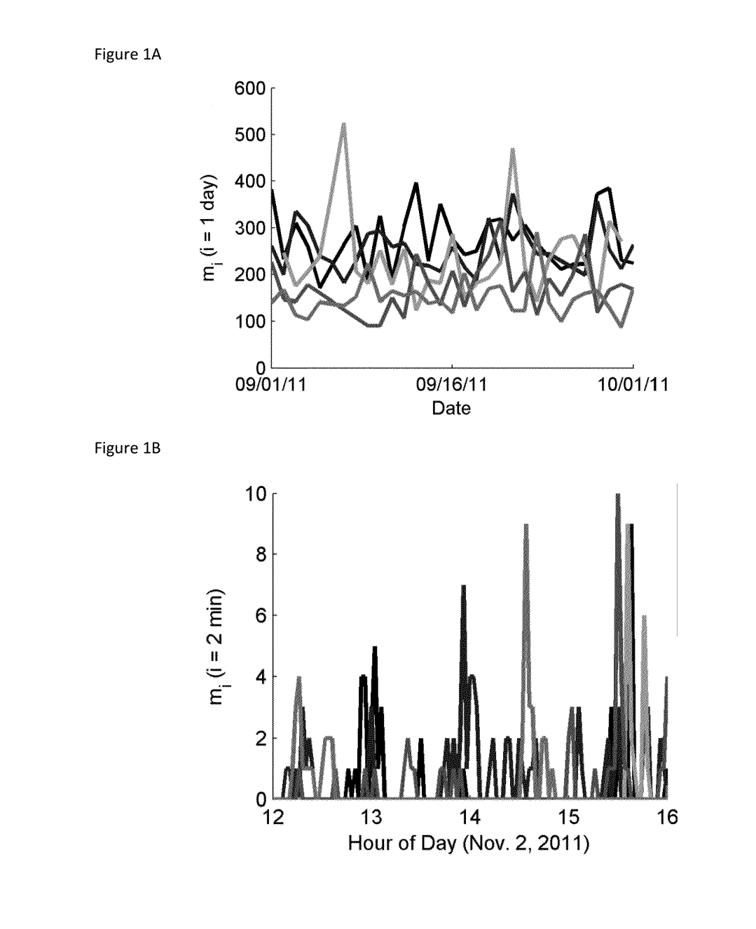

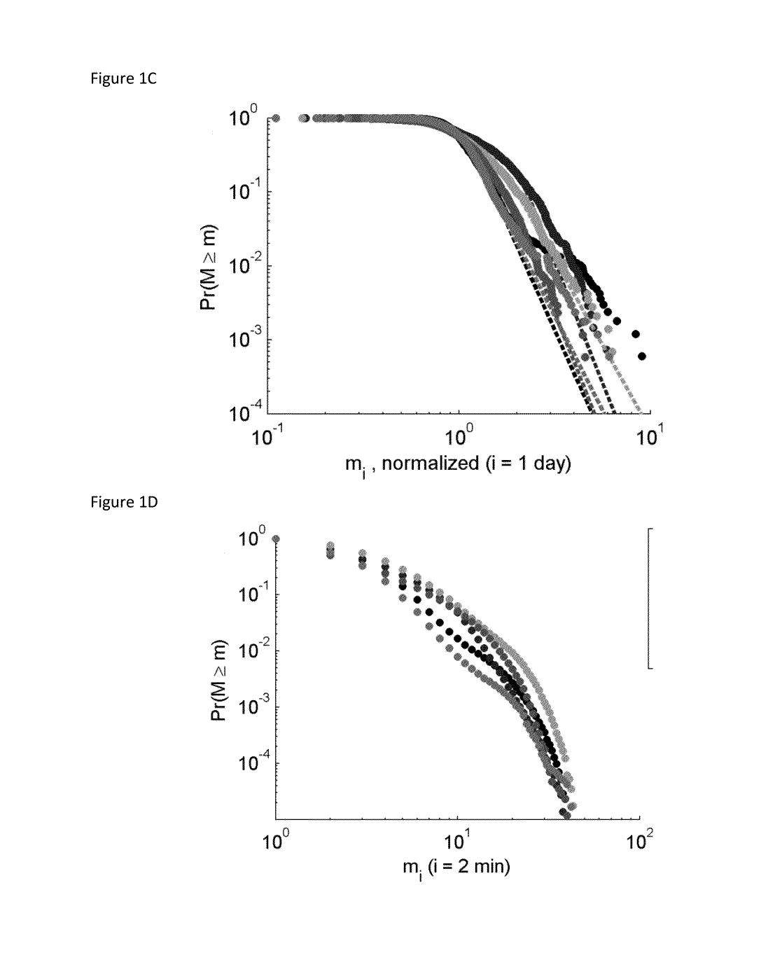

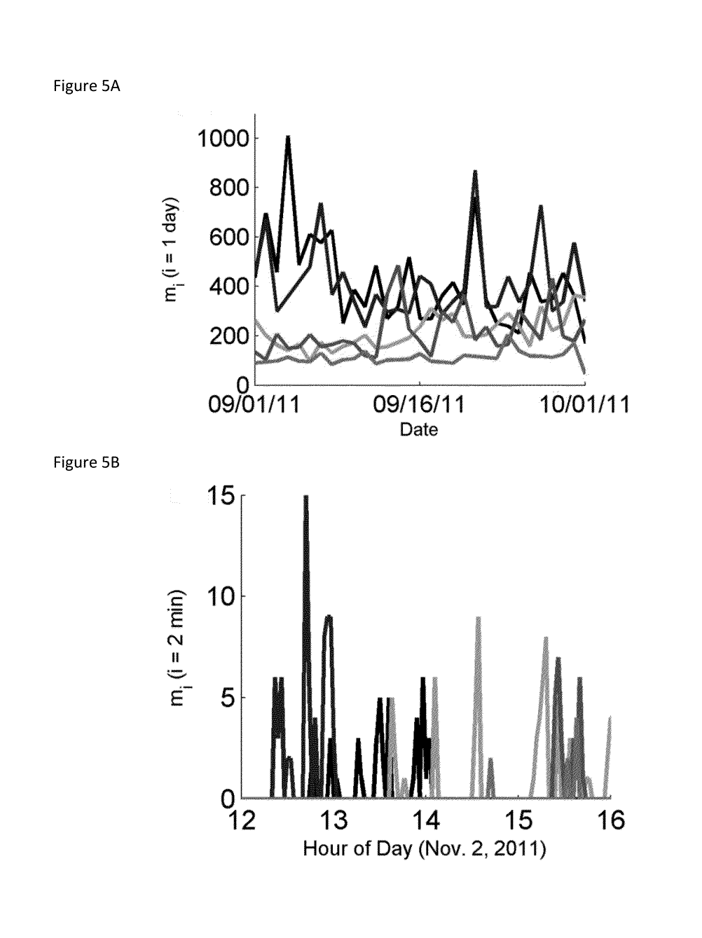

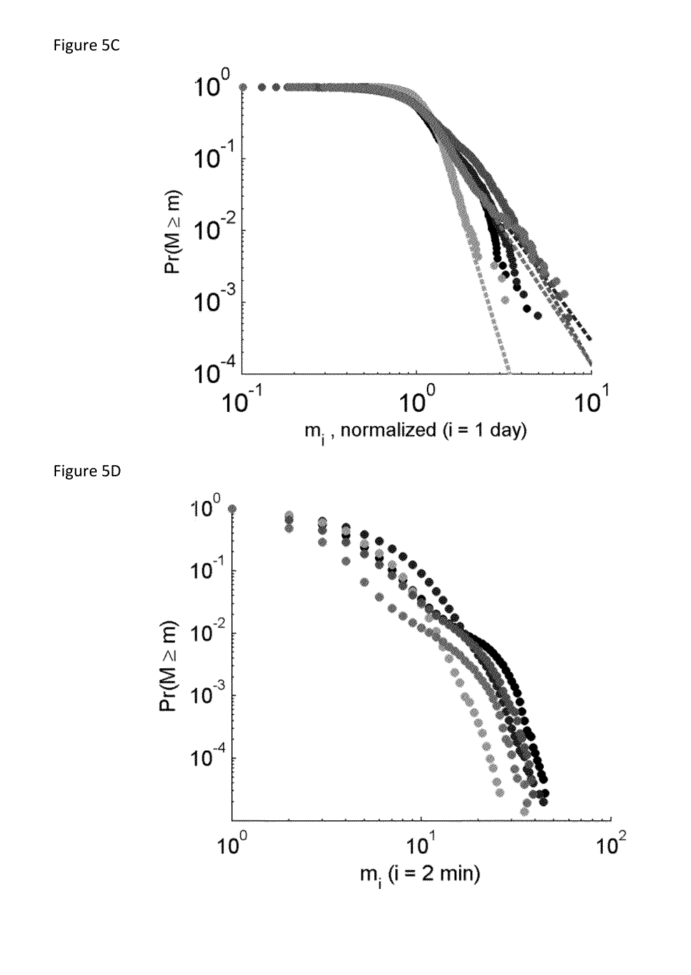

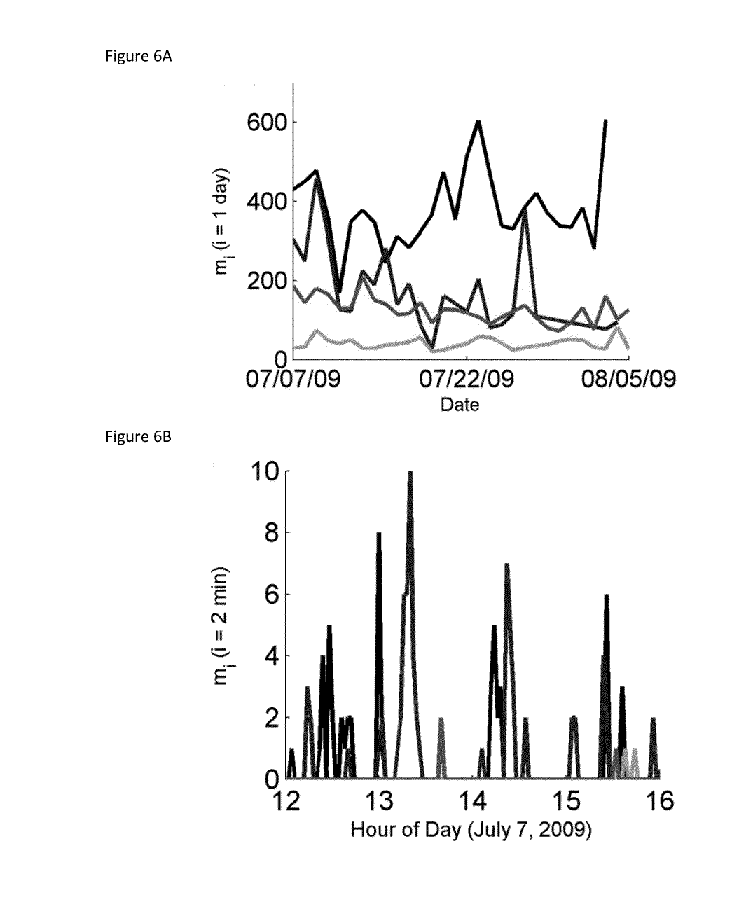

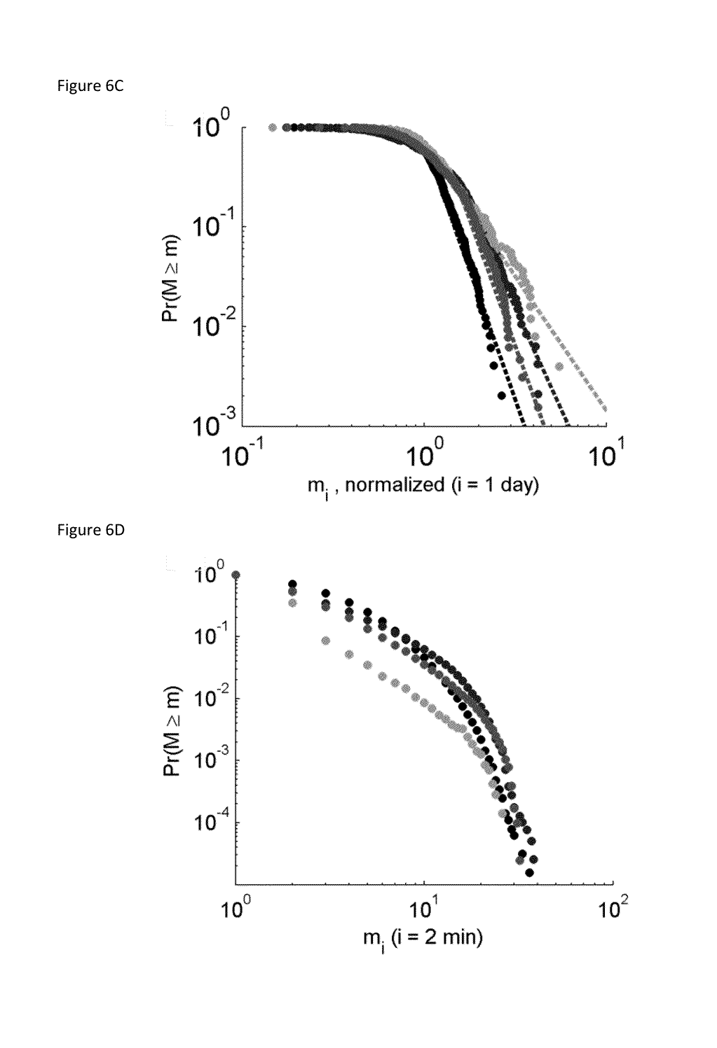

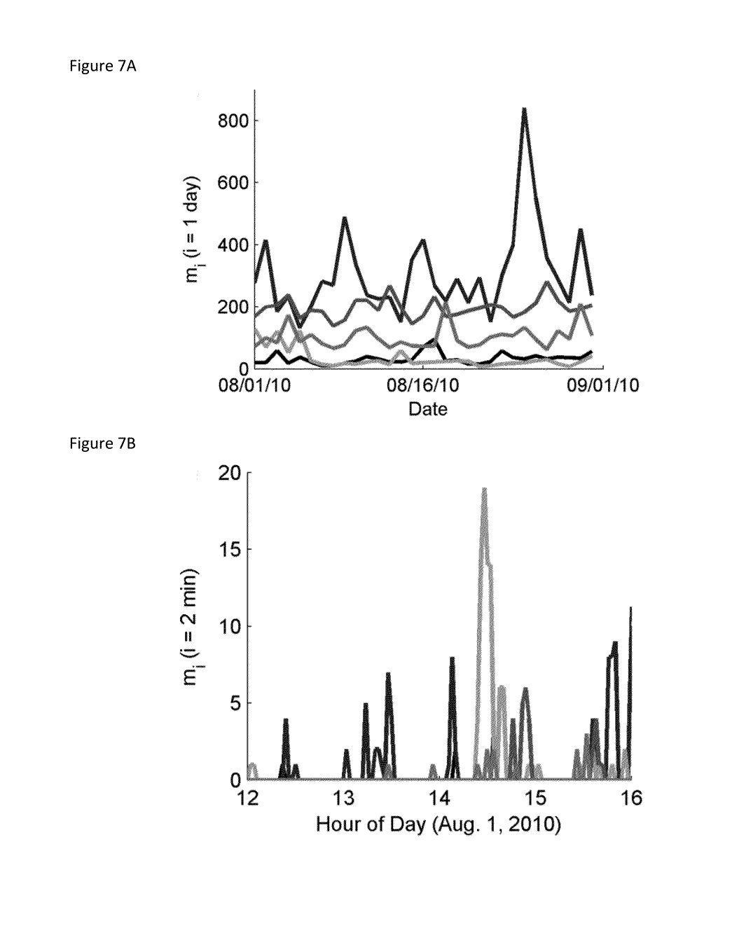

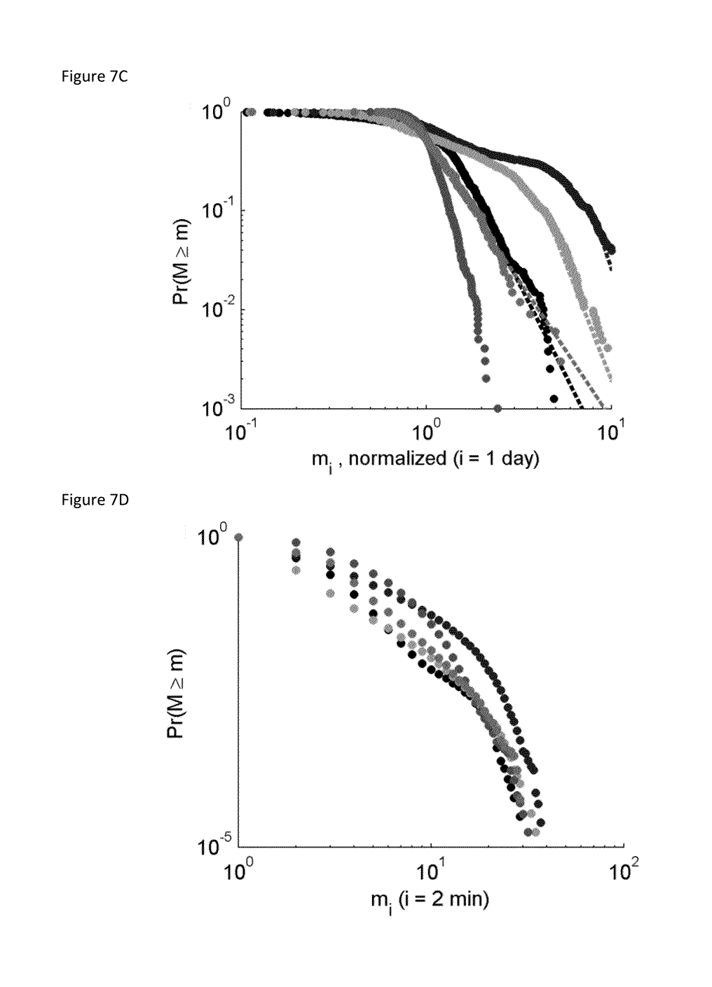

As a result, the lack of “universality” reported in the 17/19 homes for which a power law is a plausible fit at the day level could be a result of the choice of normalization. However, no constant normalization would cause the 2/19 homes at the day level or all 19 homes at the 2 minute level to follow a power law. Therefore—and perhaps most importantly—it is argued herein that a power law distribution is insufficient to adequately describe these data. Therefore, results similar to those from studies on mobility outside of the home were not seen. No normalization was applied for i=2 minutes as there was a large number of zeros in the data (mᵢ=0 for approximately 91.8% of the data at 2 minute intervals) making mean or median mobility less useful or interpretable, and the range of the data at 2-minute intervals is not largely different between homes at this granularity. FIGS. 5A-D, 6A-D and 7A-D show the results an additional 14 participants not shown FIG. 1 while Table 1 shows the power law parameter estimates for all participants.

Contextual Model—Variables: The data used in this study can be loosely broken up into 7 categories. Herein is described the origin of the data from the following categories: behavioral, weather, self-report, peer-reference, time dependence, missing data, and physical environment. All data were sampled at 2 minute intervals over the course of the study. Table 2 contains units and a brief description of all independent variables. Note that all variables here are reported in the units in which they were measured (thus remaining consistent with measurements stored in the databases from which the data were gathered); non-SI units can be converted to SI units.

TABLE 1
Power law results for mobility in one day increments after normalization for
home-specific median mobility and number of sensors installed in the
home. The distributional parameters: α, mₘᵢₙ, and mₘₐₓ are reported along with standard errors α_{SE} and mₘᵢₙ, _{SE} and the p value for the fit
(higher p values suggest a better fit). The largest observed value in the data for each home, max(m) is reported for comparison with the largest value for
which a power law is consistent (mₘₐₓ) to quantify the range over which a
power law holds. The standard errors combined with the parameter estimates show that even after normalizing for participant and measurement specific
effects, there is not a universal power law. Homes 6 and 18 were not consistent with a power law.

| Home | α | α_{SE} | mₘᵢₙ | m_{min, SE} | p value | mₘₐₓ | max(m) |
|---|---|---|---|---|---|---|---|
| 1 | 6.769 | 0.673 | 1.370 | 0.142 | 0.112 | 2.953 | 8.811 |
| 2 | 7.537 | 1.606 | 2.153 | 0.328 | 0.119 | 3.506 | 4.912 |
| 3 | 5.604 | 0.816 | 1.996 | 0.334 | 0.235 | 5.828 | 5.828 |
| 4 | 7.553 | 1.034 | 1.970 | 0.266 | 0.738 | 4.300 | 4.418 |
| 5 | 6.082 | 0.303 | 1.124 | 0.070 | 0.110 | 3.275 | 5.765 |
| 6 | — | — | — | — | — | — | — |
| 7 | 4.319 | 0.173 | 1.082 | 0.069 | 0.119 | 4.745 | 4.745 |
| 8 | 9.042 | 1.054 | 1.265 | 0.071 | 0.859 | 2.901 | 2.901 |
| 9 | 5.319 | 0.571 | 2.423 | 0.413 | 0.761 | 7.052 | 7.052 |
| 10 | 4.699 | 0.242 | 1.197 | 0.096 | 0.197 | 10.644 | 10.644 |
| 11 | 6.191 | 0.689 | 1.128 | 0.086 | 0.535 | 2.528 | 2.528 |
| 12 | 5.018 | 0.526 | 1.528 | 0.124 | 0.478 | 3.866 | 3.866 |
| 13 | 3.684 | 0.303 | 1.051 | 0.102 | 0.302 | 4.821 | 4.821 |
| 14 | 6.058 | 1.224 | 1.556 | 0.193 | 0.178 | 3.788 | 3.788 |
| 15 | 4.713 | 0.382 | 1.658 | 0.192 | 0.472 | 4.493 | 4.493 |
| 16 | 6.546 | 1.644 | 8.256 | 2.143 | 0.951 | 18.064 | 18.064 |
| 17 | 5.772 | 1.049 | 4.481 | 0.754 | 0.549 | 12.407 | 12.407 |
| 18 | — | — | — | — | — | — | — |
| 19 | 3.798 | 0.389 | 0.888 | 0.191 | 0.111 | 5.234 | 5.234 |

TABLE 2
Summary of Model. The distributional parameters: α, mₘᵢₙ, and mₘₐₓ are reported along
with standard errors α_{SE} and m_{min, SE} and the p value for the fit (higher p values suggest
a better fit). The largest observed value in the data for each home, max(m) is reported for comparison
with the largest value for which a power law is consistent (mₘₐₓ) to quantify the range over
which a power law holds. The standard errors combined with the parameter estimates show that
even after normalizing for participant and measurement specific effects, there is not a universal
power law. Homes 6 and 18 were not consistent with a power law.

| Parameter | Mean | 95% CI | | Sig | % Change | Units | Description |
|---|---|---|---|---|---|---|---|
| Pseudo-R2 | 0.665 | 0.664 | 0.665 | * | — | none | Indication of the |
| | | | | | | | quality of the |
| | | | | | | | model (model fit) |
| trantimeM | −36.442 | −56.385 | −26.512 | * | −100.00% | none | Accounts for |
| | | | | | | | missing data |
| leHour | −0.076 | −0.322 | 0.173 | | −7.36% | None | Lagged life event |
| | | | | | | | indicator; 1 hour |
| leDay | 0.020 | −0.004 | 0.043 | | 1.98% | None | Lagged life event |
| | | | | | | | indicator; 1 day |
| leWeek | 0.022 | 0.008 | 0.037 | * | 2.25% | None | Lagged life event |
| | | | | | | | indicator; 7 days |
| leMonth | 0.032 | 0.019 | 0.044 | * | 3.26% | none | Lagged life event |
| | | | | | | | indicator; 28 days |
| srf_max_temp | 0.002 | 0.001 | 0.003 | * | 0.21% | Degrees F. | Max temperature, |
| | | | | | | | 1 day forecast |
| srf_min_temp | −0.002 | −0.003 | −0.001 | * | −0.21% | Degrees F. | Min temperature, 1 |
| | | | | | | | day forecast |
| srf_prcp | 0.003 | −0.660 | 0.701 | | 0.31% | Inches | Precipitation, 1 day |
| | | | | | | | forecast |
| srf_skydesc | 0.000 | 0.000 | 0.001 | | 0.04% | none | Qualitative |
| | | | | | | | comment |
| srf_pcpdesc | 0.000 | 0.000 | 0.000 | | −0.01% | none | Qualitative |
| | | | | | | | comment |
| srf_tmpdesc | −0.003 | −0.007 | 0.001 | | −0.31% | none | Qualitative |
| | | | | | | | comment |
| srf_airdesc | 0.000 | 0.000 | 0.000 | | 0.00% | none | Qualitative |
| | | | | | | | comment |
| srf_uvindex | 0.003 | 0.001 | 0.006 | * | 0.35% | index | The UV index |
| srf_wndsped | −0.002 | −0.003 | −0.001 | * | −0.19% | mph | Wind speed |
| srf_wnddrct | 0.000 | 0.000 | 0.000 | * | −0.02% | degrees | Wind direction |
| | | | | | | (360) | |
| srf_humidty | 0.001 | 0.001 | 0.001 | * | 0.11% | percent- | Humidity |
| | | | | | | age | |
| srf_dewpoit | −0.002 | −0.002 | −0.001 | * | −0.19% | none | Dew point |
| srf_cmflevl | 0.002 | 0.001 | 0.003 | * | 0.19% | none | Qualitative |
| | | | | | | | comment |
| srf_rain24 | 0.018 | −0.686 | 0.678 | | 1.78% | inches | Rain forecast for |
| | | | | | | | the next day |
| srf_precpp24 | 0.000 | 0.000 | 0.000 | * | 0.02% | none | Probability of |
| | | | | | | | precipitation in the |
| | | | | | | | next day |
| srf_maxd | −0.001 | −0.001 | 0.000 | * | −0.09% | Degrees F. | Max temperature |
| | | | | | | | deviation from |
| | | | | | | | weekly average |
| ws | 0.000 | 0.000 | 0.001 | * | 0.04% | cm/s | Mean walking |
| | | | | | | | speed |
| ws2Min | 0.000 | 0.000 | 0.001 | * | 0.04% | cm/s | Lagged mean |
| | | | | | | | walking speed; 2 |
| | | | | | | | minutes ago |
| wsHour | 0.000 | 0.000 | 0.001 | | 0.02% | cm/s | Lagged mean |
| | | | | | | | walking speed; 1 |
| | | | | | | | hour ago |
| wsDay | 0.000 | 0.000 | 0.000 | | 0.01% | cm/s | Lagged mean |
| | | | | | | | walking speed; 1 |
| | | | | | | | day ago |
| wsWeek | 0.000 | 0.000 | 0.001 | | 0.02% | cm/s | Lagged mean |
| | | | | | | | walking speed; 7 |
| | | | | | | | days ago |
| wsMonth | 0.001 | 0.000 | 0.001 | * | 0.07% | cm/s | Lagged mean |
| | | | | | | | walking speed; 28 |
| | | | | | | | days ago |
| wsM | 0.014 | −0.001 | 0.030 | | 1.41% | none | Accounts for |
| | | | | | | | missing data |
| wsM2Min | 0.055 | 0.036 | 0.078 | * | 5.66% | none | Accounts for |
| | | | | | | | missing data |
| wsMHour | 0.022 | −0.024 | 0.062 | | 2.19% | none | Accounts for |
| | | | | | | | missing data |
| wsMDay | 0.023 | −0.023 | 0.064 | | 2.34% | none | Accounts for |
| | | | | | | | missing data |
| wsMWeek | 0.039 | −0.002 | 0.086 | | 3.98% | none | Accounts for |
| | | | | | | | missing data |
| wsMMonth | 0.066 | 0.026 | 0.106 | * | 6.86% | none | Accounts for |
| | | | | | | | missing data |
| prws | 0.003 | 0.003 | 0.003 | * | 0.28% | cm/s | Average of walking |
| | | | | | | | speed across the |
| | | | | | | | cohort |
| prwsM | 0.226 | 0.205 | 0.249 | * | 25.36% | none | Accounts for |
| | | | | | | | missing data |
| minute | 0.000 | 0.000 | 0.000 | | 0.00% | none | Minute (0-59) |
| hr | −0.001 | −0.001 | 0.000 | * | −0.09% | none | Hour (0-23) |
| day | 0.000 | 0.000 | 0.000 | | 0.01% | none | Day (0-30) |
| mth | −0.002 | −0.003 | −0.001 | * | −0.19% | none | Month (0-11) |
| yr | −0.022 | −0.025 | −0.020 | * | −2.21% | none | Year (actual; e g., |
| | | | | | | | 2011) |
| numws | 0.045 | 0.034 | 0.054 | * | 4.60% | count | Number of walks |
| | | | | | | | through sensor line |
| numws2Min | 0.016 | 0.004 | 0.028 | * | 1.57% | count | Lagged number of |
| | | | | | | | walks through |
| | | | | | | | sensor line |
| numwsHour | −0.007 | −0.033 | 0.017 | | −0.72% | count | Lagged number of |
| | | | | | | | walks through |
| | | | | | | | sensor line |
| numwsDay | 0.002 | −0.023 | 0.025 | | 0.16% | count | Lagged number of |
| | | | | | | | walks through |
| | | | | | | | sensor line |
| numwsWeek | 0.003 | −0.027 | 0.026 | | 0.31% | count | Lagged number of |
| | | | | | | | walks through |
| | | | | | | | sensor line |
| numwsMonth | 0.003 | −0.026 | 0.026 | | 0.25% | count | Lagged number of |
| | | | | | | | walks through |
| | | | | | | | sensor line |
| trantimeM2Min | −0.153 | −0.159 | −0.147 | * | −14.18% | none | Accounts for |
| | | | | | | | missing data |
| trantimeMHour | −0.034 | −0.046 | −0.024 | * | −3.38% | none | Accounts for |
| | | | | | | | missing data |
| trantimemMDay | −0.039 | −0.052 | −0.028 | * | −3.82% | none | Accounts for |
| | | | | | | | missing data |
| trantimeMWeek | −0.038 | −0.054 | −0.024 | * | −3.76% | none | Accounts for |
| | | | | | | | missing data |
| trantimeMMonth | −0.042 | −0.055 | −0.027 | * | −4.16% | none | Accounts for |
| | | | | | | | missing data |
| trantime | −0.004 | −0.004 | −0.004 | * | −0.38% | ms | Mean time to |
| | | | | | | | tranistion between |
| | | | | | | | rooms |
| trantime2Min | −0.002 | −0.003 | −0.002 | * | −0.22% | ms | Lagged mean time |
| | | | | | | | to tranistion |
| | | | | | | | between rooms |
| trantimeHour | 0.000 | −0.001 | 0.001 | | −0.01% | ms | Lagged mean time |
| | | | | | | | to tranistion |
| | | | | | | | between rooms |
| trantimeDay | 0.000 | −0.001 | 0.000 | | −0.04% | ms | Lagged mean time |
| | | | | | | | to tranistion |
| | | | | | | | between rooms |
| trantimeWeek | 0.000 | −0.001 | 0.000 | | −0.04% | ms | Lagged mean time |
| | | | | | | | to tranistion |
| | | | | | | | between rooms |
| trantimeMonth | −0.001 | −0.001 | 0.000 | * | −0.07% | ms | Lagged mean time |
| | | | | | | | to tranistion |
| | | | | | | | between rooms |
| numfir | 0.100 | 0.099 | 0.100 | * | 10.48% | count | Total number of |
| | | | | | | | sensor firings |
| numfir2Min | −0.006 | −0.006 | −0.005 | * | −0.58% | count | Lagged total |
| | | | | | | | number of sensor |
| | | | | | | | firings |
| numfirHour | 0.001 | 0.000 | 0.002 | * | 0.12% | count | Lagged total |
| | | | | | | | number of sensor |
| | | | | | | | firings |
| numfirDay | −0.001 | −0.002 | 0.000 | * | −0.12% | count | Lagged total |
| | | | | | | | number of sensor |
| | | | | | | | firings |
| numfirWeek | −0.002 | −0.002 | −0.001 | * | −0.16% | count | Lagged total |
| | | | | | | | number of sensor |
| | | | | | | | firings |
| numfirMonth | −0.001 | −0.001 | 0.000 | | −0.07% | count | Lagged total |
| | | | | | | | number of sensor |
| | | | | | | | firings |
| toh | 0.045 | 0.013 | 0.075 | * | 4.55% | propor- | Time out of house |
| | | | | | | tion | |
| toh2Min | 0.007 | −0.014 | 0.026 | | 0.66% | propor- | Lagged time out of |
| | | | | | | tion | house |
| tohHour | 0.021 | 0.013 | 0.029 | * | 2.10% | propor- | Lagged time out of |
| | | | | | | tion | house |
| tohDay | 0.020 | 0.014 | 0.026 | * | 2.01% | propor- | Lagged time out of |
| | | | | | | tion | house |
| tohWeek | 0.022 | 0.014 | 0.030 | * | 2.21% | propor- | Lagged time out of |
| | | | | | | tion | house |
| tohMonth | 0.024 | 0.017 | 0.031 | * | 2.39% | propor- | Lagged time out of |
| | | | | | | tion | house |
| numactsens | −0.056 | −0.072 | −0.041 | * | −5.47% | none | Number of active |
| | | | | | | | sensors in the |
| | | | | | | | home |
| totnumsens | 0.032 | 0.016 | 0.046 | * | 3.20% | none | Total number of |
| | | | | | | | sensors in the |
| | | | | | | | home |
| fall | 0.005 | −0.032 | 0.041 | | 0.50% | none | Indicator from |
| | | | | | | | weekly health form |
| health | 0.026 | 0.007 | 0.045 | * | 2.59% | none | Indicator from |
| | | | | | | | weekly health form |
| space | 0.025 | 0.003 | 0.045 | * | 2.57% | none | Indicator from |
| | | | | | | | weekly health form |
| blue | −0.030 | −0.061 | −0.002 | * | −2.97% | none | Indicator from |
| | | | | | | | weekly health form |
| meds | 0.028 | 0.012 | 0.046 | * | 2.81% | none | Indicator from |
| | | | | | | | weekly health form |
| hurt | 0.064 | −0.020 | 0.130 | | 6.63% | none | Indicator from |
| | | | | | | | weekly health form |
| er | 0.012 | −0.024 | 0.056 | | 1.23% | none | Indicator from |
| | | | | | | | weekly health form |
| age | −0.008 | −0.008 | −0.007 | * | −0.76% | years | Age |
| sqft | 0.000 | 0.000 | 0.000 | * | 0.00% | sqft | Square footage of |
| | | | | | | | house/apartment |
| sex | 0.018 | 0.004 | 0.032 | * | 1.78% | none | Gender |
| educ | −0.027 | −0.029 | −0.025 | * | −2.63% | years | Years of education |
| ses | 0.012 | 0.012 | 0.013 | * | 1.22% | none | Socioeconomic |
| | | | | | | | status |
| lagMDay | 0.011 | −0.085 | 0.116 | | 1.11% | none | Accounts for |
| | | | | | | | missing data |
| lagMWeek | 0.003 | −0.051 | 0.057 | | 0.34% | none | Accounts for |
| | | | | | | | missing data |
| lagMMonth | 0.001 | −0.045 | 0.046 | | 0.06% | none | Accounts for |
| | | | | | | | missing data |
| formM | 0.013 | 0.006 | 0.019 | * | 1.26% | none | Accounts for |
| | | | | | | | missing data |
| constant | 45.515 | 40.501 | 51.424 | * | — | none | Model constant |
| /Inalpha | −4.004 | −4.131 | −3.888 | * | — | none | Log of the |
| | | | | | | | dispersion |
| | | | | | | | parameter |

Physical Environment—The final category accounts for heterogeneity between participants' home space and the measurement (sensor) system. Variables accounting for the size of participants' homes (sqft), the number of sensors deployed in the home (totnumsens), and the number of working sensors (numactsens) were included. This last variable accounted for data loss during the time between when a sensor would stop working (e.g., due to a dead battery) and when a technical research assistant could get into the home space and fix the problem. A constant was also included in the model.

Contextual Model—Statistical Analysis: The approach for including context into a model for mobility involved regressing mobility onto the 88 independent variables outlined above. 88 independent variables is perhaps an order of magnitude larger than the number of variables often used in applied regression models and may raise concerns over whether the model may overfit the data. However, it can be argued that the approach is not at risk for overfitting for several reasons. First and most importantly, because of the amount of time in which the study participants have been monitored, the data set contains almost 15 million samples with which to estimate the 88 model parameters. This is a ratio of approximately 170,000 samples to each independent variable included, much larger than many other studies (many other study designs do not even gather 170,000 samples). Further, all but five of the variables vary (on different time scales) over the course of the monitoring period (age, square footage of the residence, sex, education, and socioeconomic status do not in this cohort), so even though the number of subjects included in the study is smaller than that used for many purely cross-sectional analyses, few variables that are purely cross-sectional in nature are included. Finally, the results on model fit and predictability use only 2 million samples to fit the model (a ratio of approximately 22,700 data points for each independent variable included) and test on the entire data set, thus approximately 86% of the data used to evaluate the main conclusions are not used to estimate the model parameters. Given these arguments, including a seemingly large number of independent variables in the contextual model is justified.

As mobility is a non-negative integer-valued variable, a count regression model was used. The most common count regression models include the Poisson regression model (prm) and the negative binomial regression model (nbrm), where the nbrm can be viewed as an extension of the prm that can handle overdispersion by including a parameter for unobserved heterogeneity (α; see Eq. 1). In addition to fitting these models, zero-inflated versions of both of these models were also fit to determine whether there may have been more observed zeros than can be accounted for with non-zero-inflated models. It was also found that the nbrm model offered a substantially better fit than the prm (the nbrm had a Bayesian Information Criterion 974.36 lower than the prm) and there was significant evidence of overdispersion (Likelihood-ratio test of no overdispersion: G²=988.87, p<0.0001). The zero-inflated prm or zero-inflated nbrm to could not be fit to converge to a solution, thus neither model was considered a reasonable candidate for the data generating process underlying human mobility.

After identifying the nbrm as the best model for the data out of those considered, the model in Stata (StataCorp. 2011. Stata Statistical Software: Release 12. College Station, Tex.: StataCorp LP) was fit using command nbreg. After fitting and verifying the model was significant (χ²(87)>1.24e+06; p<0.0001), the nbrm was subsequently fit 100 times with 2,000,000 randomly drawn samples (at each iteration) to estimate 95% confidence intervals on the parameter estimates which are robust to autocorrelation and heteroskedasticity. The results are shown in Table 2 along with McFadden's pseudo R2, a measure of fit for non-linear regression models, and the log of the overdispersion parameter, α (Equation 1). Of the 88 variables used in the model, 57 were found to be significantly associated with mobility as shown in Table 1. Table 1 also shows the percent change in expected mobility due to a unit change in the associated variable, holding all other variables at fixed values.

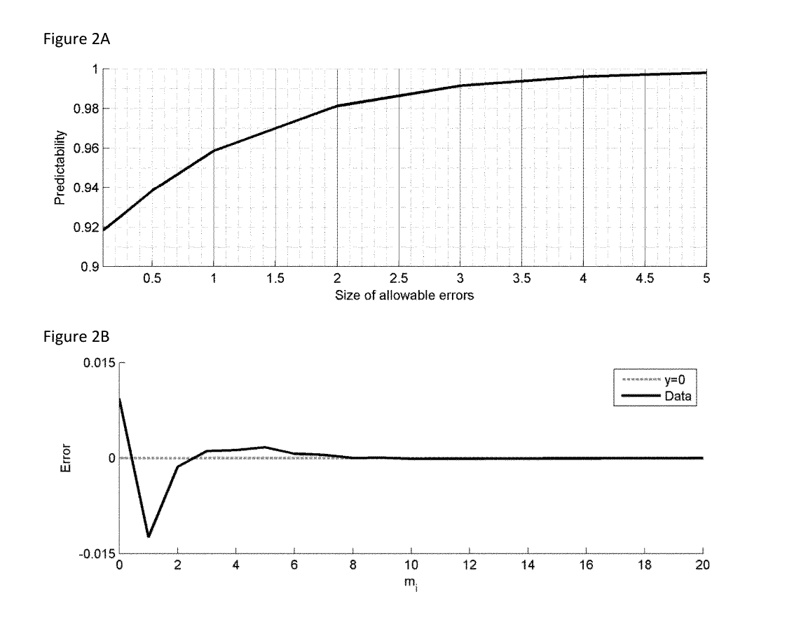

After identifying the model, the predictability, defined as prediction accuracy, was characterized in two ways (FIG. 2). First, the mobility, \hat{m}ᵢ, was estimated for all 14,920,560 samples after fitting the model with 2,000,000 samples. The prediction error (residuals), mᵢ-\hat{m}ᵢ was calculated, and the proportion of estimates whose prediction error was smaller than a certain value for several levels of prediction error. This is shown in Table 3 (see also FIG. 2A).

TABLE 3
Proportion of correct mobility estimates with 95% confidence intervals
(CI) for different values of largest allowable estimation error
(residual size; see FIG. 2A).

| | | |
|---|---|---|
| Error (Size of | Proportion of Correct | |
| largest Residual) | Mobility Estimates | 95% CI |

| | | | |
|---|---|---|---|
| 0.1 | 0.91844 | 0.91817 | 0.91870 |
| 0.25 | 0.92573 | 0.92547 | 0.92599 |
| 0.5 | 0.93838 | 0.93813 | 0.93863 |
| 1 | 0.95868 | 0.95845 | 0.95891 |
| 2 | 0.98135 | 0.98116 | 0.98153 |
| 3 | 0.99157 | 0.99142 | 0.99173 |
| 4 | 0.99616 | 0.99603 | 0.99628 |
| 5 | 0.99815 | 0.99804 | 0.99825 |

The observed and predicted mobility counts were then calculated across the whole data set (using the same model) for values of mobility between 1 and 20. This accounts for over 99.97% of the observed mobility, and is displayed in Table 4 (see also FIG. 2B).

TABLE 4
Estimated, observed, and difference in mobility probabilities
according to mobility value

| mᵢ | P(Observed) | P(Estimated) | Difference |
|---|---|---|---|
| 0 | 0.913865 | 0.923175 | −0.009311 |
| 1 | 0.028964 | 0.016521 | 0.012443 |
| 2 | 0.018402 | 0.017022 | 0.001380 |
| 3 | 0.012647 | 0.013749 | −0.001102 |
| 4 | 0.008602 | 0.009847 | −0.001245 |
| 5 | 0.004957 | 0.006647 | −0.001691 |
| 6 | 0.003678 | 0.004365 | −0.000688 |
| 7 | 0.002339 | 0.002835 | −0.000496 |
| 8 | 0.001830 | 0.001838 | −0.000008 |
| 9 | 0.001144 | 0.001198 | −0.000055 |
| 10 | 0.000915 | 0.000790 | 0.000124 |
| 11 | 0.000629 | 0.000530 | 0.000099 |
| 12 | 0.000468 | 0.000363 | 0.000106 |
| 13 | 0.000342 | 0.000254 | 0.000088 |
| 14 | 0.000258 | 0.000182 | 0.000076 |
| 15 | 0.000184 | 0.000133 | 0.000051 |
| 16 | 0.000160 | 0.000100 | 0.000060 |
| 17 | 0.000117 | 0.000076 | 0.000040 |
| 18 | 0.000090 | 0.000060 | 0.000031 |
| 19 | 0.000073 | 0.000047 | 0.000026 |
| 20 | 0.000061 | 0.000038 | 0.000023 |

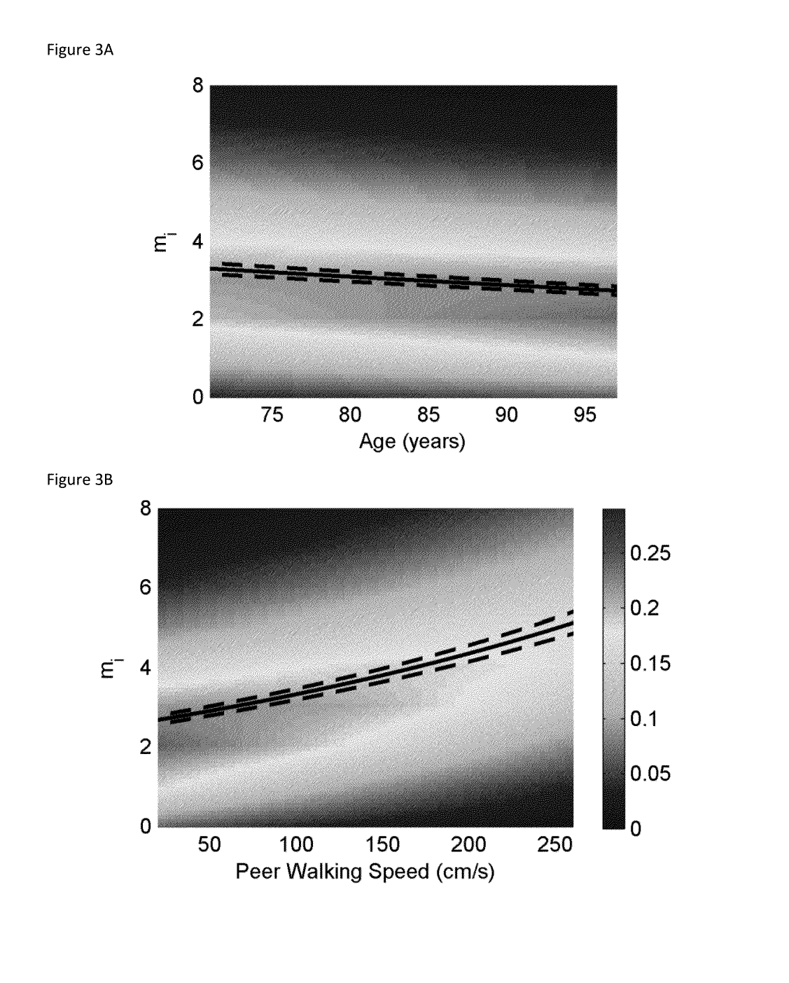

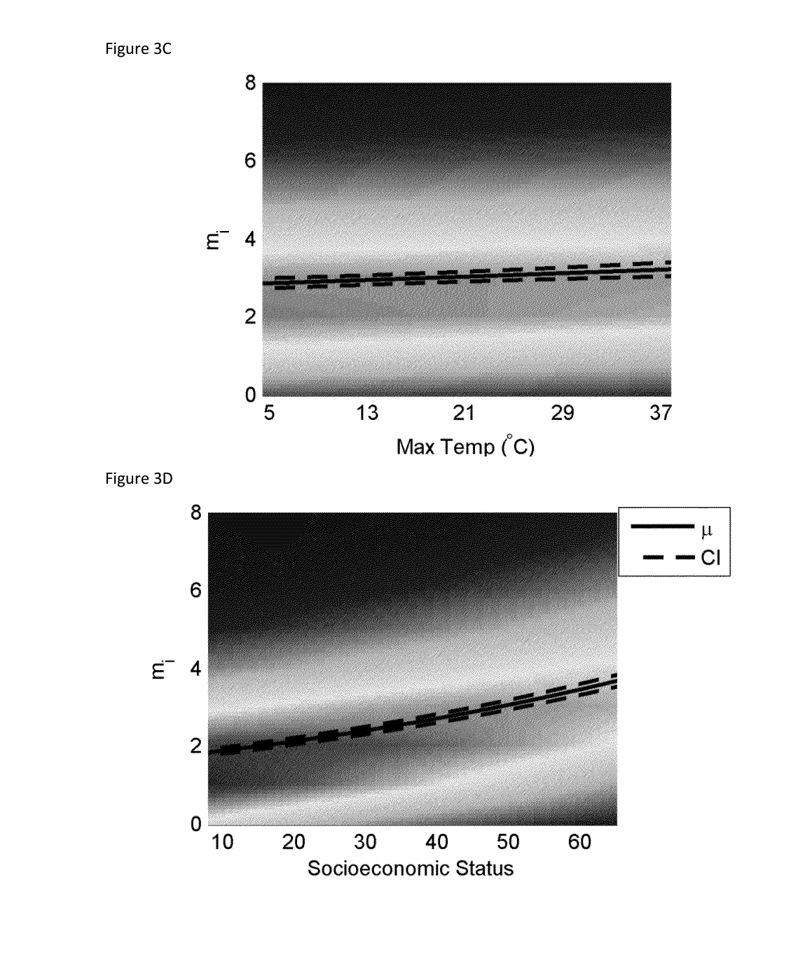

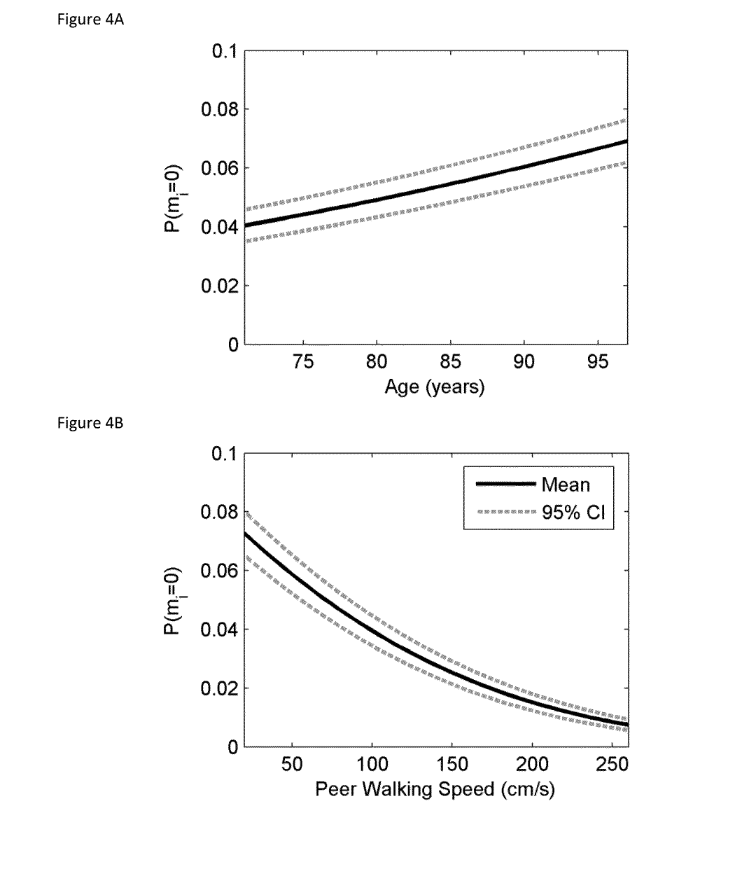

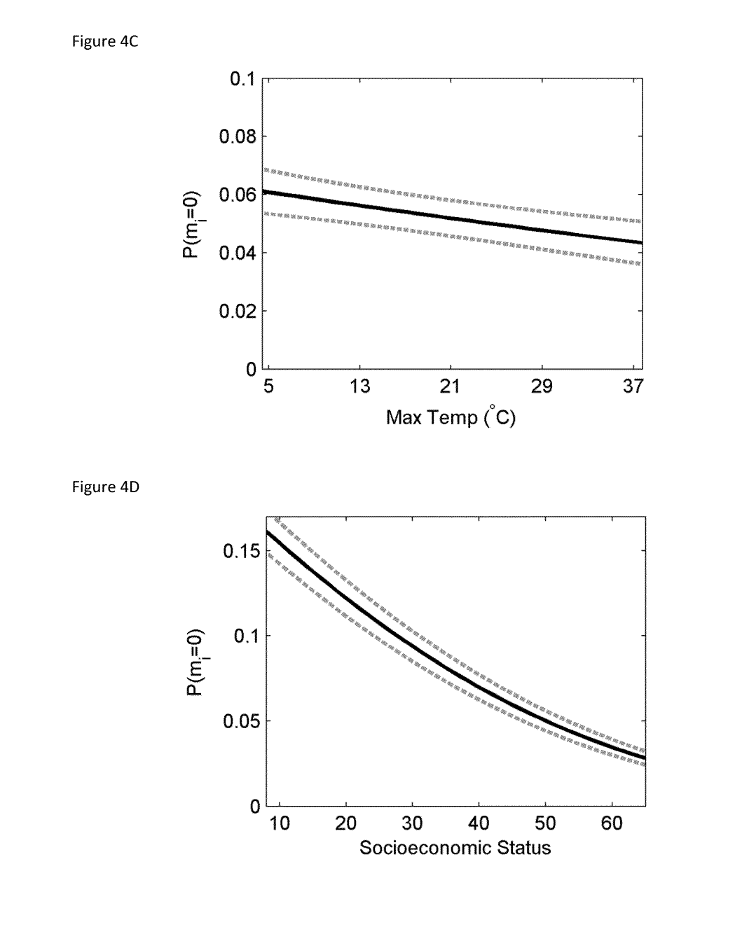

To calculate the probability density functions and probability of no transitions (as in FIGS. 3 and 4), Stata command prgen from the SPost package[14] was used with following variables set to specific values: trantimeM=0 , leHour=0, leDay=0, leWeek=0, leMonth=0, ws=60 cm/s, ws2 min=60 cm/s wsHour=60 cm/s, wsDay=60 cm/s, wsWeek=60 cm/s, wsMonth=60 cm/s, prws=80 cm/s, numws=1, numws2 Min=1, numwsHour=1, numwsDay=1, numwsWeek=1, numwsMonth=1, trantime=2 seconds, trantime2 Min=2 seconds, trantimeHour=2 seconds, trantimeDay=2 seconds, trantimeWeek=2 seconds, trantimeMonth=2 seconds, numfir=1, numfir2 Min=1, numfirHour=1, numfirDay=1, numfirWeek=1, numfirMonth=1, toh=0, toh2 Min=0, tohHour=0, tohDay=0, tohWeek=0, tohMonth=0, fall=0, health=0, space=0, blue=0, meds=0, hurt=0, er=0, sex=female, all missing data flags set to 0 (no missing data), and the remaining variables set to their mean values. This set of data represents a healthy female elderly woman of average age (with respect to the ISAAC cohort), no reported health issues, no missing data or recent overnight visitors/travel, nominal behavioral parameters, and who is walking 25% slower than her peers at present. Thus, the data represented in FIG. 3 and Extended Data FIG. 5 represents an expected mobility profile for such a woman. Similar mobility profiles for other people can be queried from the proposed model in the same way.

In order to determine regularity, the effect of time-dependence on mobility was assessed both directly as the effect of the time variables included in the model (see also Table 2; minute, hr, day, mth, and yr) and the lagged variables (multiple lags—2-minute, hour, day, week, and month—for each of the following variables: ws, numws, trantime, numfir, and toh). This allows for interpretation as both the direct effect of time and the indirect effects of time with the patterns of the other behavioral variables on specific cycles. The lagged variables also allow determination of whether there are correlations at multiple time scales. This is because if a variable is statistically significant in the model—as are all the variables ws, numws, trantime, numfir, and toh (see Table 2)—then it affects mobility. If the lag is also significant, then the same variable (just shifted in time) also affects mobility at a different point in time, thus the mobility values themselves are correlated through the original variable (at least). This indirect approach is used over something simpler (such as the autocorrelation or another higher order statistic) because the mobility process is non-stationary. Both the mean (rate) and variance of mobility change from sample to sample and thus something such as the autocorrelation does not have the simple form it would if the mobility process were stationary (e.g., R(s,t)≠R(s+t,t+t)), and is thus less interpretable and may not be calculable.

It was determined that time was statistically significant at the hour, month, and year level suggesting both infradian and ultradian mobility cycles. The day variable was not found to be significant, but this may be because day was coded as day of month, not day of week. The lagged variables were significant as follows (see also Table 2): ws was significant at a 2 minute lag and a one month lag, numws was significant at a 2 minute lag, trantime was significant at lags of 2 minutes and one month, numfir was significant at 2 minutes, an hour, a day, and a week, and toh was significant at lags of one hour, one day, one week, and one month. The analysis of the lagged variables strengthen the evidence for the presence of infradian and ultradian mobility cycles, while also suggesting the presence of circadian cycles and that correlations in mobility patterns exist at multiple time scales (at least at 2 minutes, an hour, a day, and a week). Taken together, this gives strong evidence for a high level of regularity in human mobility patterns in-the-home.

### EXAMPLES

The following examples are illustrative of disclosed methods. In light of this disclosure, those of skill in the art will recognize that variations of these examples and other examples of the disclosed method would be possible without undue experimentation.

### Example 1

### Dataset

A dataset of 14,920,560 measurements of mobility recorded in two-minute intervals from 19 older adults monitored for up to 5 years in their own homes was collected. Data were gathered from participants in the Intelligent Systems for Assessing Aging Changes (ISAAC) study (Kaye J A et al 2011 supra), a longitudinal cohort study of naturalistic aging using unobtrusive embedded home activity sensing.

### Example 2

### Power Law

The mobility data over time, mᵢ, for sampling intervals of one-day and two-minutes are shown in FIG. 1, where the sampling intervals were chosen to exemplify both gross (one-day) and fine (two-minute) grained mobility patterns. Mobility over the course of the day is comprised of bursts of movement separated by periods of little or no movement, suggesting that the large swings in day level mobility are driven by the number and size of mobility “bursts” at the two-minute level. The episodic nature of the mobility patterns at both sampling intervals coupled with results demonstrating power law behavior for out-of-home mobility suggested that a double truncated power law, M˜m^{-α} for mₘᵢₙ≦M≦mₘₐₓ, could be a reasonable characterization of the data. The double truncation is suggested on the upper side by a physiological maximum speed of an individual, which limits the amount of possible mobility in a fixed interval, and on the lower side since most empirical data tend to follow a power law only in the tail of the distribution (Clauset A et al, SIAM Review 51, 661-703 (2009); incorporated by reference herein). A power law was a reasonable fit for 17 of the 19 individuals' mobility measured at the day level (the sum of two minute mobility samples over 24 hours; shown in FIG. 1 for five homes and FIGS. 5A-D, 6A-D, and 7A-D for the remaining 14 homes) when normalizing the data by the individual specific median mobility and number of sensors in the home. However, in contrast to results reported for out-of-home mobility (Gonzalez M C et al 2008 supra), the mobility across subjects did not collapse into a single power law distribution after normalization. Instead, significant differences were found in all three parameters of the distributions (mₘᵢₙ, mₘₐₓ, and α). This suggests no universal scaling exponent governs human mobility in the home, but indicates that a high degree of individual regularity still exists. A power law was inconsistent with all mobility data when sampled at two-minute intervals, demonstrating that the impulsive nature of in-home mobility on fine-grained time scales (FIG. 1) is not well approximated by a single, individual-specific, and time-independent power law density.

### Example 3

### Contextual Model

It was then hypothesized that explicitly modeling the relationship between activity context and mobility would uncover regular and predictable structure in human mobility in-home. Because as described above, a power-law density was not a good model for mobility and because mᵢ is a non-negative integer valued variable, a negative binomial regression model was used (Long J and Freese J, Stata Corp LP, 527 (2006); incorporated by reference herein) where the probability of mᵢ—the observed mobility in a two-minute interval at sample i—follows a negative binomial distribution:

$$Pr ( {m}_{i} \vert {x}_{i} ) = \frac{Γ ( {m}_{i} + {α}^{- 1} )}{{m}_{i} ! Γ ( {α}^{- 1} )} {( \frac{{α}^{- 1}}{{μ}_{i} + {α}^{- 1}} )}^{{α}^{- 1}} {( \frac{{μ}_{i}}{{μ}_{i} + {α}^{- 1}} )}^{{m}_{i}} \qquad Equation ( 1 )$$

where x is a vector of explanatory variables, μ is the expected value of the mobility distribution satisfying ln(μᵢ)=xᵢβ, β are the model parameters describing the individual contributions of each explanatory variable, α is a dispersion parameter controlling the conditional variance of the mobility distribution, Var(mᵢ/xᵢ)=μᵢ+αμᵢ², Γ is the gamma function, and i indexes the observations. Eighty-eight explanatory variables which were hypothesized to drive human mobility and could be reliably measured were selected. These represented seven general categories: behavioral (e.g., walking speed), weather (e.g., temperature, precipitation), self-report (e.g., age, health status), peer-reference (e.g., walking speed of the peer group), time-dependence (e.g., time, lagged variables), missing data, and physical environment (e.g., home size). Variables from the first five categories were included to directly account for the influence between observed context, observed phenomena, and mobility, while the last two categories were included to account for missing data and known heterogeneity across both subjects and home space.

The contextual model allows the determination of two important questions: 1) is in-home mobility predictable? and 2) is in-home mobility regular? If the model uncovers predictability and regularity in human mobility, it can be inferred that context is an important part of human mobility patterns. Further, a context-based model that adequately approximates human mobility allows inferences on the relationship between contextual variables and mobility. To investigate these questions, data were fit to the model described by equation (1) above. The model was found to be both statistically significant and an accurate representation of the data. In the data set disclosed herein, 91.4% of the observations are 0 (no mobility) with a range of observed mobility values from 0 to 41 across the entire data set. Therefore, predictability must be substantially higher than 91.4% to be meaningful. Predictability was first considered as a function of estimation error—the difference between observed and estimated mobility values (FIG. 2A). It was determined that if the error is 3 transitions or less (a 7% error with respect to the range of data), then the model has over 99% predictability. Predictability was quantified as differences in estimated and observed mobility counts in the data set (FIG. 2B). The model overestimates periods of no movement by 1%, underestimates periods with a single movement by 1.2%, and is within 0.2% or less of observed values for all other values of mobility. Taken together, these results demonstrate a high degree of predictability is present in human home-space mobility when context is taken into account.

Regularity can be quantified in several ways. Of particular importance in the contextual model is the spread of the 95% confidence interval on the expected mobility and model parameters. In these cases the uncertainty in model estimates are determined by a convolution of measurement/modeling error, heterogeneity across participants, and heterogeneity in mobility within a person over time. For example, an 80 year old female (holding all other variables constant at specified values) has an expected mobility of 3.1 transitions with 95% confidence intervals of (2.97, 3.23; FIG. 3A). The expected mobility is highly regular because the confidence intervals on the estimate, which by definition contain 95% of the values that would occur under a repeated measurement of the same 80 year old female or different 80 year old females all having the same fixed values of the other variables during the measurement, are narrow around the estimate. Similar statements can be made about model parameters, other expected mobility values, and probability statements (see FIG. 4). With this interpretation, the model results indicate a high degree of regularity in human mobility patterns, while also providing a way in which to assess whether model parameters should be stratified across subjects (wide confidence intervals suggest stratification) or are representative of the population.

While in-home mobility does not appear to follow a universal scaling law, accounting for context uncovers both regularity and predictability in this mobility in a way in which a single time-independent scaling distribution cannot. Further, in-home mobility is highly stereotyped both within and across subjects when context is taken into account. This result is potentially useful for behavioral forecasting (predicting patterns of mobility over time), especially since deviations from highly stereotyped in-home behavior may have significant and broad application in predicting both acute and long-term illness or wellness such as in predicting personal health status (Chon Y et al, 2012 IEEE Int Conf Pervasive Comp Comm pp 206-212 (2012); incorporated by reference herein) or in conducting more meaningful clinical trials.

### Example 4

### Subjects

Data from 19 subjects enrolled in the Intelligent Systems for Assessing Aging Changes (ISAAC) study were used. The ISAAC study is a longitudinal community cohort study consisting of standardized clinical and neuropsychological testing combined with a continuous and unobtrusive in-home assessment platform in an elderly population in the Portland, Oreg. (USA) metropolitan area. Enrollment in the study was based on 5 main criteria: being 80 years of age or older at study enrollment, living without a formal caregiver, living in a residence larger than a one-room studio apartment, being cognitively healthy, and in average health for the age of the participant. There was relaxation of the age requirement for spouses of enrolled participants or minority participants. From this cohort of 265 residents (some cohabitating), a subset of 19 subjects were selected who lived alone and did not have persistent long term technical issues with the in-home assessment platform. Of these 19 subjects, 16 were female and the mean age was 87.4 years (±6.6 years).

### Example 5

### In-Home Monitoring Platform

Every home in the ISAAC cohort was equipped with a set of sensors, a computer for personal use, and a computer to collect the sensor data wirelessly through an attached transceiver. The sensor set consisted of two types of sensors—infrared motion sensors and contact sensors. Both types of sensor would transmit a unique code wirelessly when activated, which was detected by the transceiver and time stamped by the attached data computer. The data were uploaded to a remote database each night over the Internet.

One infrared motion sensor was placed in each room of the residence to provide room location information. A set of four motions sensors with a restricted field of view (approximately four degrees) was placed in a linear array in a confined space (such as a hallway) and used to estimate speed of walking. Contact sensors were placed on all entrances/exits in the home and were used to detect when a resident left the home.

1. A computer-implemented method of identifying in-dwelling mobility patterns of a subject, the method comprising:
collecting data from two or more sensors in a dwelling of the subject;
determining a contextual variable associated with the dwelling, the subject, and/or the environment surrounding the dwelling;
calculating a mobility pattern within the dwelling based upon the data and the contextual variables using a regression model.

2. The method of claim 1 further comprising indicating a degraded functional status of the subject in response to an actual in-dwelling mobility pattern for the subject deviating from an expected in-dwelling mobility pattern for the subject.

3. The method of claim 1 wherein the regression model comprises a negative binomial regression model.

4. The method of claim 3 wherein the negative binomial regression model comprises the following equation:
$$Pr ( {m}_{i} \vert {x}_{i} ) = \frac{Γ ( {m}_{i} + {α}^{- 1} )}{{m}_{i} ! Γ ( {α}^{- 1} )} {( \frac{{α}^{- 1}}{{μ}_{i} + {α}^{- 1}} )}^{{α}^{- 1}} {( \frac{{μ}_{i}}{{μ}_{i} + {α}^{- 1}} )}^{{m}_{i}} .$$

5. The method of claim 1 wherein the contextual variable comprises contextual information associated with one or more of behavioral information of the subject, weather information in vicinity of the dwelling, self-reported information by the subject; peer-reference information of the subject, time dependent information, missing data information, and physical environment information of the dwelling.

6. The method of claim 5 wherein the contextual variables comprise one or more of numfir, ws, numws, trantime, toh, srf_max_temp, srf_min_temp, srf_maxd, srf_tmpdesc, srf_prcpp24, srfprcp, srf_rain24, srf_pcpdesc, srv_wndsped, srf_wnddrct, srf_dewpoit, srf_humidity, srf_uvindex, srf_skydesc, srf_cmfdesc, srf_airdesc, ses, educ, sex, age, time of day, day of week, day of month, week of year, or month of year.

7. The method of claim 1 comprising collecting data from five or more sensors in a dwelling.

8. A system used in identifying in-dwelling mobility patterns of a subject, said system comprising:
two or more sensors placed in the dwelling of the subject, and
a computing device coupled to the two or more sensors, wherein said computing device is programmed to determine a contextual variable associated with the dwelling, the subject, and/or the environment surrounding the dwelling and calculate a mobility pattern within the dwelling based upon the data and the contextual variables using a regression model.

9. The system of claim 8 wherein the system indicates a degraded functional status of the subject in response to an actual in-dwelling mobility pattern for the subject deviating from an expected in-dwelling mobility pattern for the subject.

10. The system of claim 8 wherein the regression model comprises a negative binomial regression model.

11. The system of claim 10 wherein the negative binomial regression model comprises the following equation:
$$Pr ( {m}_{i} \vert {x}_{i} ) = \frac{Γ ( {m}_{i} + {α}^{- 1} )}{{m}_{i} ! Γ ( {α}^{- 1} )} {( \frac{{α}^{- 1}}{{μ}_{i} + {α}^{- 1}} )}^{{α}^{- 1}} {( \frac{{μ}_{i}}{{μ}_{i} + {α}^{- 1}} )}^{{m}_{i}}$$

12. The system of claim 8 wherein the contextual variable comprises contextual information associated with one or more of behavioral information of the subject, weather information in vicinity of the dwelling, self-reported information by the subject; peer-reference information of the subject, time dependent information, missing data information, and physical environment information of the dwelling.

13. The system of claim 12 wherein the contextual variables comprise one or more of numfir, ws, numws, trantime, toh, srf_max_temp, srf_min_temp, srf_maxd, srf_tmpdesc, srf_prcpp24, srfprcp, srf_rain24, srf_pcpdesc, srv_wndsped, srf_wnddrct, srf_dewpoit, srf_humidity, srf_uvindex, srf_skydesc, srf_cmfdesc, srf_airdesc, ses, educ, sex, age, time of day, day of week, day of month, week of year, or month of year.

14. The system of claim 8 comprising five or more sensors.
